(19) United States
(12) Patent Application Publication
(10) Pub. No.: US 2023/0300125 A1
(43) Pub. Date: Sep. 21, 2023

(54) PASSWORD AUTHENTICATION SYSTEM

(71) Applicant: Keisuke KIDO, Yokohama-shi (JP)

(72) Inventor: Keisuke KIDO, Yokohama-shi (JP)

(21) Appl. No.: 18/020,543

(22) PCT Filed: Nov. 2, 2021
(86) PCT No.: PCT/JP2021/040418

§ 371 Date: Feb. 9, 2023

(30) Foreign Application Priority Data
Nov. 19, 2020 (JP) 2020-192419

(51) Int. Cl. H04L 9/40

(52) U.S. Cl. CPC H04L 63/083; H04L 63/1483

(57) ABSTRACT

The present invention provides a password authentication system in which a high security level can be maintained using a password with small number of digits. According to the invention, an operation result with a large number of digits is generated by logically operating using a user password memorized in the user's brain and a unique code which is secretly stored on the terminal device and is set for each website. The authentication processing is performed by using the operation result as an authentication password. Therefore, the user simply remembers the password with a small number of digits in his brain, and the authentication processing is performed using the complex password with a large number of digits. Furthermore, a different authentication password is outputted for each website just using one user password. As the result of this, the problem of the users forgetting their password is solved and the security level of the password authentication can be significantly improved. By acquiring the address of the website being accessed and logically operating by use of the address information of the website, the problems of the reuse and the phishing scam can be solved.

### TECHNICAL FIELD

The present invention relates to a password authentication system in which a high security level can be maintained even though using a password with small number of digits.

Further, the present invention relates to a password authentication system in which effective measures against reuse and a phishing scam are taken.

### BACKGROUND ART

A password authentication in which personal authentication is performed using user identification information (user ID) and a password can be built by software, and so it has an advantage of low implementation cost. Also, such password authentication has versatility to use anywhere. And, with the spread of SSL communication, the risk of password eavesdropping on the communication path has been greatly reduced. For these reasons, the password authentication becomes widespread.

However, the password authentication has a drawback that the password may be easily guessed by hackers. If the password is stolen, it is used illegally and great damage will occur. To deal with these problems, if the number of digits of the password is increased, the risk of password guessing is reduced. However, if the number of the digits of the password is increased, it becomes difficult to keep remembering the set password and the risk of forgetting the password will occur. On the contrary, if a simple decimal bit password is used, the risk of forgetting the password is reduced, but the risk of the password being stolen may increase.

With the spread of the Internet, there are many users having a number of accounts. For such users, it is virtually difficult to set and remember the different password for each site, and thus the same password is frequently reused for the multiple sites. However, some sites are vulnerable to security. In this case, when the site with vulnerable security is attacked by the hacker and the password is flowed out, the safety of the other sites where the same password is used may be damaged. Especially, even for secure sites like a financial institute, if the password is leaked out from the other site due to the reuse, a risk of unauthorized use may occur even if it has a high degree of security. Therefore, it is also an important subject to overcome the problem due to the reuse.

Furthermore, the damages caused by the fact that the password is stolen by phishing scams are occurring frequently. Therefore, it is an urgent task to protect users from the phishing scams. As the measure against the password reuse and the phishing scams, a method of writing down a password on a paper, a method of saving a password in an electronic file, and a method of storing the password using a management tool are proposed (for example, see non-patent document 1).

NPLT1: What is password list attack? Causes of damage and countermeasures (May 14, 2019 updated)

### SUMMARY OF INVENTION

### Technical Problem

With the above described method of writing down the password on the paper, there is no risk of the password being stolen over the network, but there is a risk of the paper loss or theft. Further, with the method of saving the password in the electronic file and the method of storing the password using the management tool, the password exists within the terminal device and thus the password may be leaked out by the attack of the hacker. That is, the fact is that the password authentication method currently in practical use has not been sufficiently dealt with the problems caused by the password reuse and the problem against phishing scams.

Furthermore, in a service industry using the Internet, the password authentication system is actually widespread. Thus, there is an urgent need to improve the security level of the authentication systems that are actually in operation at many sites without making major changes. Therefore, it is strongly demanded to develop the password authentication that can effectively deal with the reuse of the password and the phishing scams in the password authentication system currently in operation by simply taking simple improvement measures.

The object of the present invention is to provide a password authentication system which can maintain a high security level using a simple password with small digits without significantly changing the current password authentication system.

Another object of the invention is to provide a password authentication system which can solve the problem caused by the reuse of the password.

Further, another object of the invention is to realize a password authentication system which can maintain a high security level and is effective against the problems caused by the reuse of the password and the countermeasure for the phishing scams.

### Solution to Problem

The password authentication system according to the invention comprising an authentication server for performing personal authentication using an authentication password, and terminal devices through which users operate, wherein

said terminal device comprises an input means for inputting a user password, a unique code storage means for storing a unique code set for each user, an operation means for logically operating by use of the unique code stored in the unique code storage means and the user password inputted by the user to output an operation result as the authentication password, and a means for transmitting the generated authentication password together with user identification information to the authentication server, and wherein

said authentication server comprises a password storage means for storing the authentication password included in a password registration request sent from the terminal device together with the user identification information as a registration password which functions as a reference for authentication, and a verification means for verifying the match between the authentication password included in the password authentication request sent from the terminal device and the registration password which is stored in the password storage means and is specified by the user identification information included in the password authentication request, and wherein

when setting up, the terminal device logically operates using the user password and the unique code stored in the unique code storage means to generate the authentication password, and transmits the password registration request which includes the generated authentication password to the authentication server, and the authentication server stores the authentication password included in the password registration request together with the user identification information in the password storage means as the registration password, and wherein

when performing the password authentication, the terminal device logically operates using the user password and the unique code stored in the unique code storage means to generate the authentication password and transmits the password authentication request including the generated authentication password to the authentication server, and the authentication server verifies the match between the authentication password included in the received password authentication request and the registration password which is stored in the password storage means and is specified by the user identification information included in the received password authentication request.

Upon performing personal authentication, the user inputs his own user password being preserved confidentially in his brain to the terminal device. The terminal device logically operates using the inputted user password and the unique code which is stored in the terminal device to output the arithmetic result as the authentication password. The generated authentication password is transmitted together with the user identification information to the authentication server installed in the website via the network. The authentication server verifies the matching between the authentication password sent from the terminal device and the registration password registered in the authentication server. By using this configuration, the following four advantageous effects are attained.

As a first effect, the few digit user password inputted into the terminal device by the user is converted to the multi-digit authentication password by logically operating using the unique code, and the personal authentication is performed using the authentication password with a large number of digits. As the result of this, since the information entropy of the authentication password used in the authentication step is substantially increased, a security level equivalent to that is obtained when the authentication is performed using a multi-digit authentication password having a large information entropy can be obtained, and thus the security level is greatly increased. On the other hand, since the user password held by the user is sufficient to be a character string or a sequence of a small number of digits, the burden on the user is reduced and the problem of the user forgetting the user password is solved.

Further, the user password is logically operated using the unique code held in the terminal device to generate the authentication password which become a criteria for authentication. Therefore, even if the user password is leaked out, the authentication password won't be known to the third party unless the unique code is not known. And also, even if the unique code held in the terminal device is known to the third party, the authentication password will not be known unless the user password is not known. Therefore, the safety of the authentication system of the invention is sufficiently improved rather than the conventional password authentication system.

As a second effect, the problem caused by the reuse is solved. According to the invention, though the user simply uses one and the same user password, it is possible to output a different authentication password for each website. That is, according to the invention, since the code string set for each website can be used as the unique code, the logical operation can be performed using a different unique code for each website. In this case, even if one and the same user password is used, a different authentication password is outputted for each website. As the result of this, even if the user uses the same password for a plurality of websites, a different authentication password is used for each website and thus the problem caused by the reuse is solved. Further, even when accessing a plurality of websites, the user simply enters one and the same user password into the terminal device, and thus the burden on the user is substantially reduced.

As a third effect, the authentication password which is used in the password authentication step is not stored in the terminal device. That is, according to the invention, since the user password to be held by the user only needs to be a simple string or sequence of a few digits, the user password can be clearly memorized in the user's brain. Further, since the authentication password used for the actual verification is outputted as a logical operation result of the user password and the unique code, the authentication password exists only temporarily in the terminal device during the authentication processing. That is, the user password and the authentication password which are used in the authentication step exist only temporarily in the terminal device during the authentication processing. Therefore, the risk that the authentication password is stolen by the hacker is greatly reduced.

Further, as a fourth effect, the current password authentication system in practical use can be changed to a password authentication system in which a security level is significantly improved without making any special changes to the current password authentication system. Namely, in the set up work, it is only necessary to install on the terminal device a terminal module which converts a minor digits user password into a multi-digits authentication password, and making special changes to the authentication server is not necessary. That is, in the authentication server, there is registered an account including a user ID and a registration password. Therefore, the authentication server can perform the personal authentication only by verifying the matching between the authentication password included in the received authentication request and the registration password registered in the account. In this way, it is not necessary to make any special changes to the authentication server, and only by installing the terminal module which converts the user password into the authentication password with multi-digit in the terminal device, the authentication system currently in practical use can be used as it is.

The technical features of the invention can be summarized as follows. That is, without making any special changes to the authentication server currently in practical use and only by installing the terminal module which convert the small digits user password inputted by the user into the authentication password with multi-digits, the high security level password authentication system in which the problem caused by the reuse is solved can be realized.

According to the invention, the unique code is set for each user. As the unique code, the address information of the website such as the domain or URL of the website, the information unique to the user such as the client information set to the user by the website, or encryption information in which the user ID or a user's mail address is encrypted with a private key of the management server or authentication server can be used. For example, the domain and URL of the website are different for each website, and therefore even though using one fixed user password, if the logical operation is performed using the user password and the domain or URL of the website, the different authentication password can be set for each website.

As the logical operation using the user password and the unique code, various hash operations and encryption operations can be used. As an example, the user password and the unique code are coupled to perform the hash operation on the coupled code data. The obtained hash value is used as the authentication password. For example, the user password with two digits and the unique code with 256 digits (2048 bits) are coupled to perform a 256 hash operation on the connected code data, and thereby the authentication password with 256 bits is generated. In this case, by simply memorizing a two-digital number as the user password, the authentication process is performed using the authentication password with 32 digits (256 bits), and therefore the burden on the user is substantially reduced and the security level of the system becomes considerably higher.

Another password authentication system according to the invention comprising an authentication server for performing personal authentication using an authentication password, and terminal devices through which users operate, wherein

said terminal device comprises an input means for inputting a user password, an address acquisition means for acquiring address information of a website being accessed, an operation means for logically operating by use of the address information acquired by the address acquisition means and the user password inputted by the user to output an operation result as the authentication password, and a means for transmitting the generated authentication password together with user identification information to the authentication server, and wherein

said authentication server comprises a password storage means for storing the authentication password included in a password registration request sent from the terminal device together with the user identification information as a registration password which functions as a reference for authentication, and a verification means for verifying the matching between the authentication password included in a password authentication request sent from the terminal device and the registration password which is stored in the password storage means and is specified by the user identification information included in the password authentication request, and wherein

when setting up, the user accesses the desired website, the terminal device acquires the address information of the website being accessed and logically operates using the acquired address information and the user password to generate the authentication password and transmits a password registration request which includes the generated authentication password to the authentication server, and the authentication server stores the authentication password included in the password registration request together with the user identification information in the password storage means as the registration password, and wherein

when performing the password authentication, the user accesses the desired website, the terminal device acquires the address of the website being accessed, logically operates using the acquired address and the user password to generate the authentication password, and transmits the password authentication request including the generated authentication password and user identification information to the authentication server, and the authentication server verifies the matching between the authentication password included in the received password authentication request and the registration password which is stored in the password storage means and is specified by the user identification information included in the received password authentication request.

According to the invention, the address information of the website or authentication server being accessed is acquired using the address acquisition means installed in the terminal device. Since the addresses of the websites vary from site to site, by performing the logical operation using the address of the website or authentication server, the authentication passwords which differ for each website are generated even though using the same user password. As the result of this, even though using the same user password, the authentication process is performed by use of the different authentication password for each authentication server or website, and thus the need to reuse the password is omitted and the problem caused by the reuse of the password is solved.

The defense effect against the phishing fraud by the password authentication system of the invention will be explained. According to the authentication system of the invention, in response to the generation of the authentication password, the address of the authentication server or webserver being accessed is acquired to generate the authentication password using the acquired address information and the use password. Therefore, each authentication server has a unique registration password that is different for each website. For example, in case of performing the user authentication with ◯◯◯ bank's authentication serer, the address information of ◯◯◯ bank' site such as URL or a part of URL is acquired upon setting up the authentication process. And then the logical operation is performed using the acquired address of ◯◯◯ bank' site, the user password remembered by the user and the unique code stored in the terminal device to output the operation result. Then, the outputted operation result becomes the authentication password, is transmitted to the authentication server, and is registered as the registration password.

Thereafter, if a normal authentication request is performed, the terminal device acquires ◯◯◯ bank's address prior to the generation of the authentication request. Subsequently, the logical operation is performed using the acquired address, the user password inputted by the user and the stored unique code, and the operation result becomes the authentication password. And then, the authentication request including the generated authentication password is transmitted to the authentication server. Since this authentication password is generated using the same operation codes as the registration password stored in the authentication server, this authentication password matches the registration password in the authentication processing performed in the authentication server. And thus, this authentication request is judged as normal, and login is allowed.

On the contrary, if the user is accidentally directed to a phishing site, a login screen that looks almost same as the ◯◯◯ bank's login screen is displayed on the user's monitor. Thereby, the user believes that the login screen displayed on the user's monitor is the formal ◯◯◯ bank's login screen, and thus the user generates the authentication password to enter it on the login screen. And then, the entered authentication password is transmitted to the phishing site.

However, the authentication password which is sent to the phishing scam site is a different code bit sequence from the normal registration password registered as the ◯◯◯ bank's password. That is, even if the user is directed to the phishing site, the address acquisition function operates to acquire the address of the website being accessed prior to the generation of the authentication password. However, since each website has a different addresses set for each site, the acquired address is different from the ◯◯◯ bank's normal address. Therefore, the terminal device carries out the logical operation using the wrong address different from the ◯◯◯ bank's normal address, the user password and the unique code. Then, the terminal device outputs the wrong operation result which differs from the official operation result, because the operation code is different. As a result, the authentication password transmitted to the phishing site becomes the wrong code bit sequence which differs from the official registration password. Therefore, the authentication password cannot be stolen even in the face of the phishing scam. Namely, according to this password authentication system, the terminal device acquires the address of the webserver being accessed depending on the generation of the authentication password, and so it is possible to counter the phishing scam effectively.

In the above explanation, the logical operation was performed using the user password, the unique code and the website's address to generate the authentication password, but it is possible to generate the authentication password by performing the logical operation using the user password and the address of the website being accessed without using the unique code

A terminal device according to the invention used in a password authentication system comprising the terminal devices through which users operate, and an authentication server for performing personal authentication using an authentication password sent from the terminal device, wherein

said terminal device comprises an input means for inputting a user password, a unique code storage means for storing a unique code set for each user, an operation means for logically operating by use of the unique code stored in the unique code storage means and the user password inputted by the user to output an operation result as the authentication password, and a means for transmitting the generated authentication password together with user identification information to the authentication server, and wherein

when performing the personal authentication, the terminal device logically operates using the user password inputted by the user and the unique code stored in the unique code storage means to generate the authentication password, and transmits a password authentication request including the generated authentication password and the user identification information to the authentication server.

The prior terminal device which has been used in the password authentication system currently in use comprises the means for inputting the user password and the means for transmitting the user password to the authentication server together with the user ID. Therefore, the terminal device according to the invention is completed by simply installing a terminal module which comprises the unique code storing means and the logical operation means for logically operating using the user password inputted by the user and the unique code sored in the unique code storage means. Therefore, by simply installing the simple terminal module into the prior terminal device, the terminal device in which the security level is significantly improved is realized.

Another terminal device according to the invention used in a password authentication system in which personal authentication is performed using an authentication password, wherein

said terminal device comprises an input means for inputting a user password, an address acquisition means for acquiring address information of a website being accessed, an operation means for logically operating by use of the address information acquired by the address acquisition means and the user password inputted by the user to output an operation result as the authentication password, and a means for transmitting the generated authentication password together with user identification information to the authentication server, and wherein

when performing the personal authentication, said terminal device acquires the address of the website being accessed, logically operates using the acquired address and the user password inputted by the user to generate the authentication password, and transmits a password authentication request including the generated authentication password and the user identification information to the authentication server.

### ADVANTAGEOUS EFFECT OF INVENTION

According to the invention, the arithmetic processing is performed using the user password inputted by the user and the unique code confidentially stored in the terminal device to generate the authentication password with a large number of digits, and the authentication process is performed using the authentication password with a large number of digits. Therefore, the user only needs to memorize a simple password with a small number of digits to perform a complex authentication process using the complicate password with a large number of digits. And thus, the problem that the use forgets the password is solved, and the security level can be significantly improved.

Furthermore, in the password authentication system according to the invention, the unique code used in the logical operation can be set for each website and can be different for each website. Therefore, using one and the same user password, a different authentication password can be generated for each website. As the result of this, even though using one and the same user password for a plurality of websites, the authentication processing can be performed using a different authentication password for each website, and thus the problem caused by the reuse can be solved.

As the unique code, a website-specific code bit sequence or a use-specific code bit sequence can be used. As the website-specific code bit sequence, the address information or the domain of the website or the authentication server installed on the website can be used. As the user-specific bit code, the information given to the user by the website or the authentication server can be used. For example, the user information such as a bank's “customer number” is assigned to the user by each bank's site, and to a same person the different user information is set for each site. Therefore, by incorporating the user information into the operation code and performing the logical operation, it is possible to output the different authentication password for each website even if the same user password is used.

Furthermore, in the password authentication system of the invention, the terminal device comprises the address acquisition means for acquiring the address of the website being accessed. And, prior to the generation of the authentication password, the terminal device obtains the address information of the website being accessed, incorporates the acquired address into the operation codes to perform the operation processing, and outputs the operation result as the authentication password. Since the domain or the address of each site is different for each site, a different authentication password for each site can be outputted, even though the same user password is used. Thereby, the problem caused by the reuse can be solved. Further, even if the user is directed to the phishing site and is requested to enter the password, the logical operation is performed by incorporating the address of the phishing site into the operation codes, and thus the sequence or string that does not match the authentication password of any websites is entered into the phishing site. Thereby, the problem of password theft by phishing can be solved.

As a comprehensive effect, according to the invention, the problems of the password reuse and the phishing scam can be solved at once by using the simple password with a small digits that is easy to remember in the user's brain, and a password authentication system in which the security level is significantly improved can be realized. Furthermore, the present invention can be carried out by simply installing the terminal module for converting the user password into the authentication password with a large number of digits on the terminal device used in the password authentication system currently in operation.

### BRIEF DESCRIPTION OF DRAWINGS

FIG. 1 is a view showing a whole configuration of the password authentication system according to the invention.

FIG. 2 is a view showing the authentication process of the password authentication system according to the invention.

FIG. 3 is a view showing the functional configuration of the terminal module installed on the terminal device.

FIG. 4 is a view showing the functional configuration of the authentication server.

FIG. 5 is a view showing a modified example of the functional configuration of the terminal module.

### EMBODIMENTS OF INVENTION

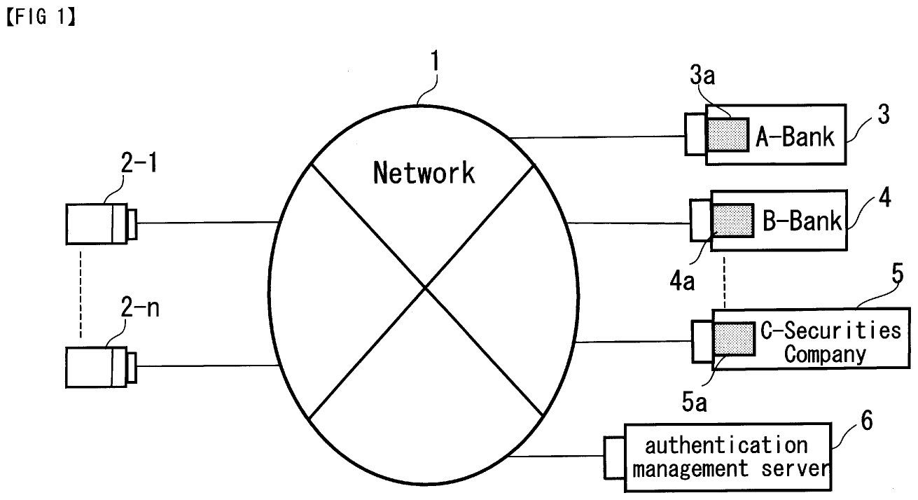

FIG. 1 is a diagram showing a whole configuration of the password authentication system according to the invention. A plurality of terminal devices 2-1 to 2-n through which users operate are connected to the network 1. Further, to the network 1, there are connected the website 3 of Bank A, the website 4 of Bank B, and the website 5 of Stock company C. These websites comprise authentication servers 3a to 5a for performing personal authentication, respectively, and authentication requests from the terminal devices are processed by the authentication servers 3a to 5a, respectively. In the present invention, instead of setting a different user password for each website to perform the personal authentication, a particular different authentication password is generated for each website using one user password on the terminal device, and the personal authentication is performed using the particular authentication password for each website. In other words, according to the invention, the user simply specifies the desired website and enters the same user password into the terminal device, and a different authentication password is generated for each website, and thus the user authentication is performed using the unique different authentication password for each website.

Furthermore, an authentication management server 6 is connected to the network 1, and it is possible to apply to a plurality of ID/PW authentication servers by single sign-on through the authentication management server.

The basic configuration of the password authentication system according to the invention will be described. The basic idea of the present invention is to perform a logical operation using a minority-digit user password secretly remembered in the user's brain and a multi-digit operational code which is set for each website and is stored in the terminal device to output code data with a large number of bits. The outputted code data is used as the password used for the actual authentication work, that is, as the authentication password.

Upon setting up, the authentication password outputted from the operation means is sent to the authentication server of the website via the network and is stored as a registration password that acts as a criterion for authentication. This registration password is stored in the database together with the user identification information. When performing the personal authentication, the user password is entered into the terminal device by the user, and the logical operation is executed using the user password entered by the user and the unique code of the website specified by the user to generate the authentication password. The generated authentication password is sent to the authentication server via the network, the matching with the registration password stored in the database is verified, and if they matches, it is determined that this authentication request is an authentication request by a person with a legitimate authority, and thus the user can log in. By using this mechanism, it is possible to output a multi-digit authentication password using a simple user password with a small number of digits, and a high security level which is substantially equal to the case of performing the personal authentication using the multi-digit password with large information entropy is achieved. Moreover, since both the user password and the authentication password are not preserved in the terminal device, the risk of such passwords being stolen by a hacker is eliminated.

The further developed password authentication system of the invention can solve both the problems caused by the password reuse and by the phishing fraud at once. That is, in another password authentication system of the invention, the terminal device has a means for acquiring the address information of the website being accessed, and acquires the address of the website being accessed in response to the generation of the authentication password. Then, the acquired address is incorporated into the operation code, the operational processing is performed, and the operation result is output as the authentication password. Since the address and domain of each website are different for each site, the different operation result is generated for each accessed website by incorporating the address of the website into the operation code and performing the logical operation. As a result, even if the same user password is used, the different authentication password is generated for each website, and the user authentication can be performed using the different authentication password for each site.

Furthermore, since the domain or the address of the site being accessed is acquired, even if the user is directed to the phishing site and is requested to enter the user password, the domain of the phishing site is incorporated into the operation codes to perform the logical operation. And thus, a sequence or a string that does not correspond to the authentication passwords of any sites is entered into the phishing site, and therefore the official authentication password will not be entered into the phishing site. In this way, the password authentication system of the present invention can solve both the problem caused by the password reuse and the problem against phishing fraud at once.

As a logical operation formula, following logical formulas can be used depending on the purpose.

[User password+Unique code]×Hash operation=Hash value (1)

The user password and the unique code with more bits than the user password are concatenated, and the hash operation is executed for the concatenated bit string. The obtained hash value is used as the authentication password. In this example, the user password with a small number of digits is converted into the authentication password with a large number of digits. Therefore, the possibility that the user forgets his or her password is reduced, and the security level can be further increased as well.

[User password+Unique code+Site information (for example a domain or a URL of a website)]×Hash operation=Hash value (2)

The domain and the URL of the website are different for each site. Therefore, if the domain of the website is used as the operation code set for each website, the operation code differs for each website even though the same user password is used for each website, and thus it is possible to generate a different authentication password for each website. Thereby, the problem caused by the password reuse is solved. It should be noted that it is possible to perform the logical operation using only the user password and the site information without using the unique code.

[User password+Unique code+User information (for example “customer information” set for the user by the webserver)]×Hash operation=Hash value (3)

The information set for the user by the website such as customer information or an account number is different for each website. Therefore, by using the user information set by the website as the operation code, it is possible to set a different authentication password for each website. In this case, the logical operation can be performed using only the user password and the user information as well.

[User password+Unique code+Address information of the website being accessed]×Hash operation=Hash value (4)

The addresses of the website and the authentication server are different for each server. Therefore, when generating the authentication password, by acquiring the address of the authentication sever being accessed and performing the logical operation using the acquired address, it is possible to set a different authentication password for each website even though using the same user password. Further, upon generating the authentication password, by acquiring the address of the authentication sever being accessed and performing the logical operation using the acquired address, even if the user is directed to a phishing site, a wrong code string is simply outputted and the code sequence that corresponds to the password registered on any of the sites cannot be outputted. And thus, it is extremely effective against the phishing scams.

[User password+Unique code+Domain of the website being accessed]×Hash operation=Hash value (5)

[User password+Address information of the website being accessed]×Hash operation=Hash value (6)

If the user password and the website address provide an authentication password with a sufficient number of digits, it is not necessary to use the unique code.

[User password+Domain of the website being accessed]×Hash operation=Hash value (7)

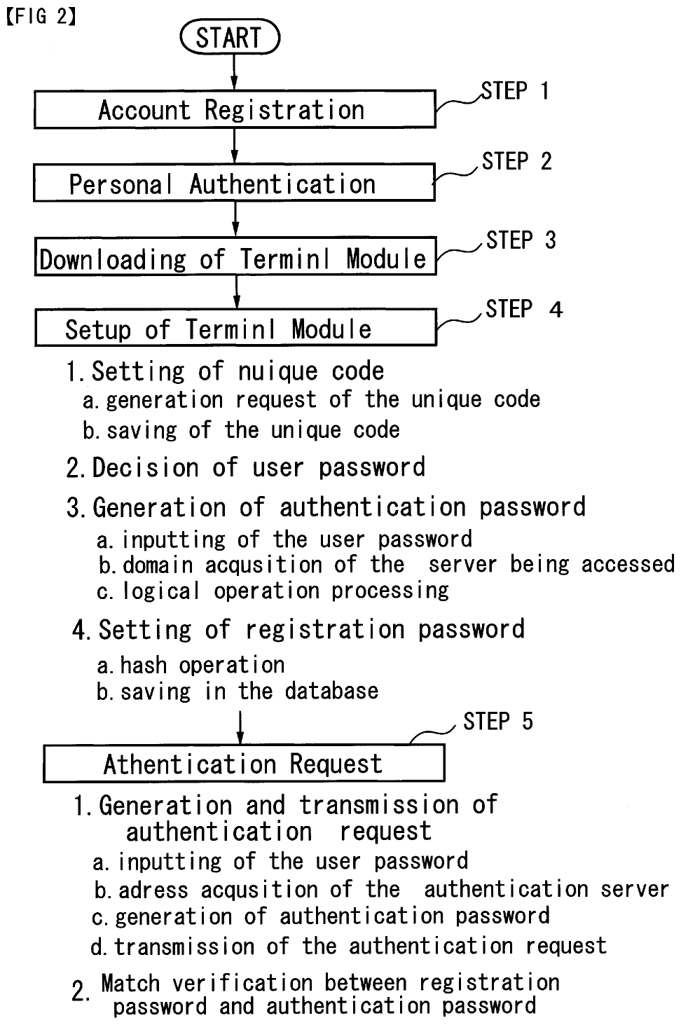

FIG. 2 is a diagram showing an example of a concrete authentication process of the password authentication system according to the invention. In the present example, the setting up is performed by installing the terminal module of the invention on the terminal device of the password authentication system currently in use. And, as the operation codes, the user password, the unique code and the address of the website being accessed are used.

Firstly, the user accesses to the authentication server of the target website to generate an account (step 1). The account includes a user ID, a user's mail address and a password for personal authentication.

The authentication server performs the personal authentication after checking the basic information (step 2). Upon performing the personal authentication, the authentication server sends an authentication link to the mail address registered in the account. The user clicks the authentication link and enters the user ID and the password for the personal authentication. The authentication server verifies the consistency between the inputted password and the password included in the account.

If the identity verification is successful, the authentication server sends an installing file of the terminal module (step 3). The terminal module includes a sequence of functions of the terminal device in the password authentication, and the authentication processing is performed between the authentication server and the terminal device through the various functions of the terminal module. However, when the terminal module has already been installed on the terminal device, the installing file of the terminal module is not transmitted.

Setting up the downloaded terminal module is performed (step 4). First, the user sets the unique code used for the logical operation. In this example, a 24-digit random number generated by the authentication server is used as the unique code. The user sends a unique code generation request from the terminal device to the authentication server. In response to the reception of the unique code generation request, the authentication server operates a random number generator to generate a 24-digit random number and sends it to the terminal device. The terminal device stores the received 24-digit random number as the unique code.

Then, the user decides the user password and keeps it secret in his or her brain. It is desirable that the user password is a password that is hard to forget.

Next, the authentication password used for the authentication process is generated. In this example, the logical operation formula is based on the following logical formula.

[User password+Unique code+Domain of website being accessed]×Hash operation=Hash value

The terminal device concatenates the user password, the unique code, and the domain of the site being accessed and performs the hash operation. The outputted hash value becomes the authentication password. Various arithmetic expressions can be used as the logical operation formula, for example, an SHA1 hash operation and an SHA256 hash operation can be used. It is also possible to use an encryption operation formula such as DES56.

Next, the terminal device transmits a password registration request including the outputted authentication password together with the user identification information to the authentication server being accessed. The authentication server stores the authentication password included in the received password registration request as the registration password in the database together with the user identification information, and then the setup processing is completed. This password registration request also includes the information required to register the authentication password as the registration password. The received authentication password can be used as it is as the registration password. Or, the received authentication password is hashed to generate a hash value and the hash value may be stored in the database together with the user identification information as a registration password. In this example, the hash value generated from the received authentication password is used as a verification target. By doing so, the authentication password is not stored in the terminal device and in the authentication server, and even if the hacker succeeds in intrusion, the authentication password cannot be retrieved.

Subsequently, the authentication processing performed in the password authentication step (step 5) will be described. Upon requesting authentication, the user accesses the authentication server of the target website. Subsequently, the user inputs the own user password via the input means. When the user password is entered, the address acquisition means is activated to acquire the address of the website being accessed. Then, a logical operation is performed using the inputted user password, the acquired address, and the unique code to generate the authentication password. Subsequently, the authentication request including the generated authentication password and the user identification information is generated, and the authentication request is sent to the authentication server.

The authentication server extracts the authentication password from the received password authentication request and performs the hash operation processing to generate the hash value. And then, the authentication server searches the data base using the user identification information included in the authentication request to find the associated registration password, and the matching between the searched registration password (hash value) and the hash value of the authentication password is verified. If they match, the authentication server certifies that it is a valid authentication request and allows login.

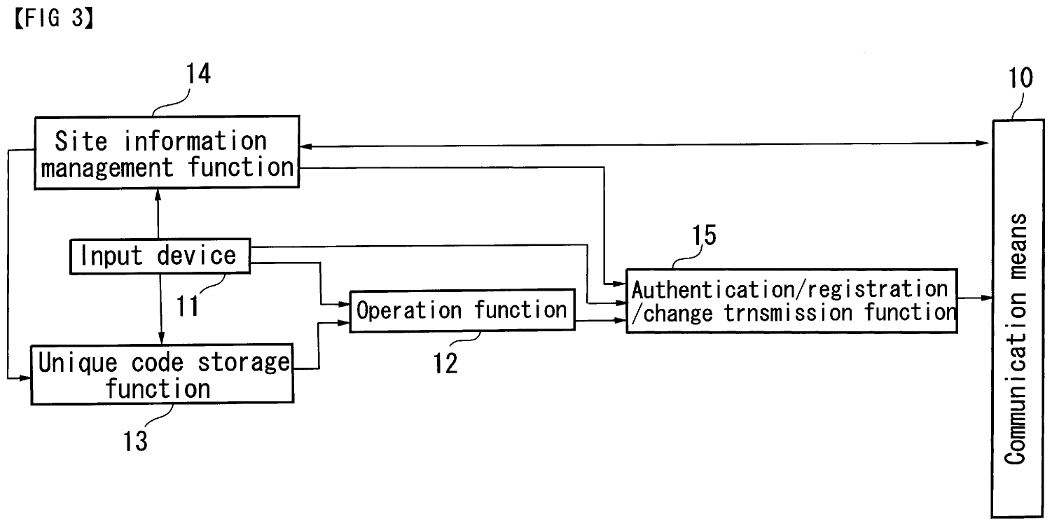

FIG. 3 shows an example of the functional configuration of the terminal module installed on the terminal device. It should be noted that only the part related to the user authentication among the functions of the terminal device is shown. In this example, a logical operation is performed using the user password and the unique code to generate an authentication password. The terminal device has a communication means 10 and accesses the authentication server of the website through the communication means. The communication means comprises basic browser functions including an SSL encryption communication function. The terminal device has an input device 11 such as a keyboard for example, and the user inputs the user password through the input device 11. The entered user password is supplied to an operation function 12. The user also specifies the website that is subject to the password authentication via the input device. The site designation information is supplied to the unique code storage function 13. The unique code storage function 13 stores a site name and a unique code in a paired relationship for each website. The unique code of the website specified by the user is supplied to the operation function 12.

Further, the terminal module has a site information management function 14. The site information management function 14 manages the information about the websites. For example, accessing the website where the authentication is required and acquiring the unique code, and storing the acquired unique code in the unique code storage function 13 is performed.

The operation function 12 performs the hash operation using the inputted user password and the unique code to output the operation result as the authentication password. The outputted authentication password is supplied to an authentication/registration/change request transmission function 15. The user sends the instruction indicating whether the authentication password corresponds to the authentication request, the registration request, or the change request to the authentication/registration/change request transmission function 15 via the input device. Further, the destination information of the authentication password is supplied from the site information management function 14. For example, when performing the password authentication, the authentication/registration/change request transmission function 15 is instructed that the entered authentication password is related to the password authentication request, and the address of the website to be transmitted is specified by the site information management function 14. Then, the authentication/registration/change request transmission function 15 creates the password authentication request including the authentication password and the user identification information and transmits the generated password authentication request to the designated website via the communication means 10.

When the user wishes to change the user password, the user inputs the changed user password into the input device. Further, the website name related to the password change is supplied to the unique code storage function 13 and the site information management function 14. The operation function 12 performs the logical operation using the changed user password and the unique code of the website related to the password change, and outputs the changed authentication password to the authentication/registration/change request transmission function 15. The authentication/registration/change request transmission function generates a password change request including the changed authentication password and the user identification information and sends it to the authentication server.

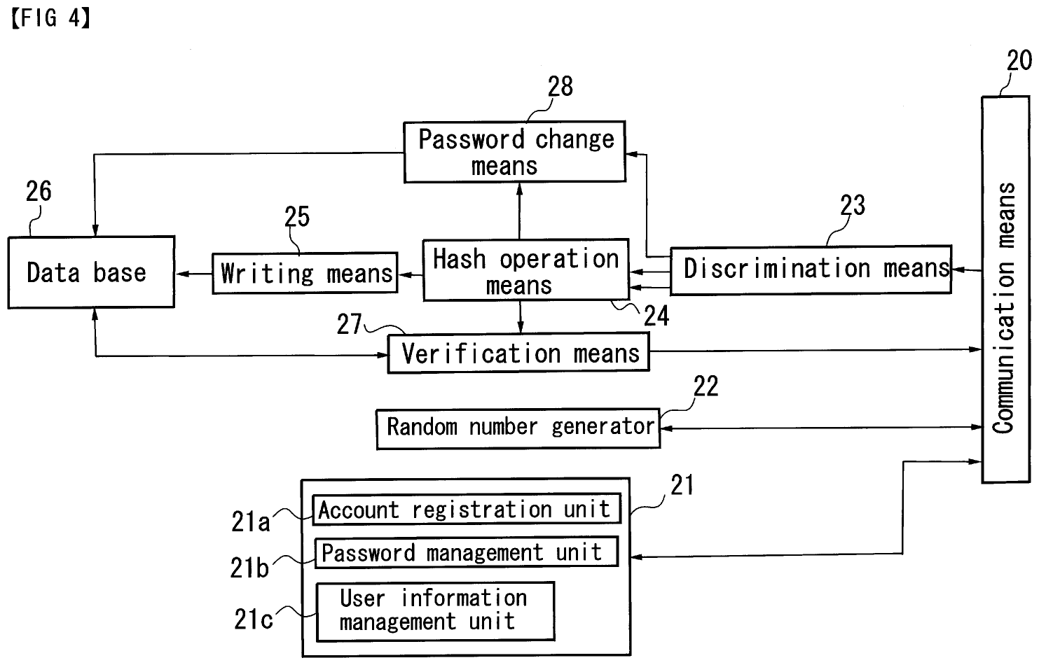

FIG. 4 shows an example of the functional configuration of the authentication server. Only the configuration related to the user authentication is shown. The authentication server has a communication means 20. The communication means 20 has the SSL server certificate issuing function and the SSL encryption communication function. The authentication server has an account management unit 21, and the account management unit 21 has an account registration unit 21a, a password management unit 21b, and a user information management unit 21c. The account registration unit 21a assigns the user information to each terminal device and initializes the password. The password management unit 21b stores the password sent from the terminal device when the password is changed or the like. The user information management unit 21c stores the information about the user including the user's e-mail address, telephone number, and unique code configuration information.

The authentication server has a random number generator 22 to generate a random number having a predetermined number of digits in response to receiving a unique code generation request from the terminal device, and transmits the generated random number to the terminal device.

The authentication server has a discrimination means 23 to discriminate whether the request signal sent from the terminal device is the password registration request, the password authentication request, or the password change request. The discrimination means 23 supplies the discrimination information indicating the authentication request and the like, the authentication password, and the user identification information to the hash operation means 24. The hash operation means 24 performs the hash operation on the input authentication password to calculate the hash value.

When the password registration request is inputted, the hash value calculated by the hash operation means is supplied to a writing means 25 together with the user identification information and is written to a database 26 as the registration password by the writing means.

When the password authentication request is inputted, the hash value calculated by the hash operation means is supplied to a verification means 27. Further, a database 26 is searched using the user identification information, and the hash value (registration password) specified by the user identification information included in the authentication request is found and supplied to the verification means. The verification means verifies the matching between the two hash values. If they match, the password authentication request is determined to be normal. If they do not match, the password authentication request is treated as an error.

When the password change request is inputted, the hash value calculated by the hash operation means and the user identification information are supplied to the password change means 28. The password change means searches the database using the user identification information included in the change request to figure out the hash value (registration password) specified by the user identification information and rewrite the hash value (registration password) specified by the user identification information included in the change request with the hash value (new authentication password) related to the change request. In this way, changing the password is completed by simply rewriting the registered password stored in the database with the new authentication password.

The above-mentioned authentication server is almost the same as the authentication server to which the password authentication system currently in operation is applied. Therefore, the present invention can be applied to the password authentication system currently in operation. In this case, the required work is simply changing and resetting the registration password stored in the database. That is, the user installs the terminal module of the invention on the terminal device and performs the setup work. After the setup work is completed, the user determines the user password and inputs it through the input means, and then the logical operation is performed to generate the authentication password. Subsequently, the password change request including the generated authentication password and the user identification information is generated, and the generated password change request is sent to the authentication server. The authentication password and user identification information are inputted into the hash operation means. The hash value calculated by the hash operation means and the user identification information are supplied to the password changing means 28. The password changing means searches the database using the user identification information included in the change request, and rewrites the hash value specified by the user identification information included in the change request with the hash value related to the change request. Thereby, the setup work is completed and the password authentication work can be performed.

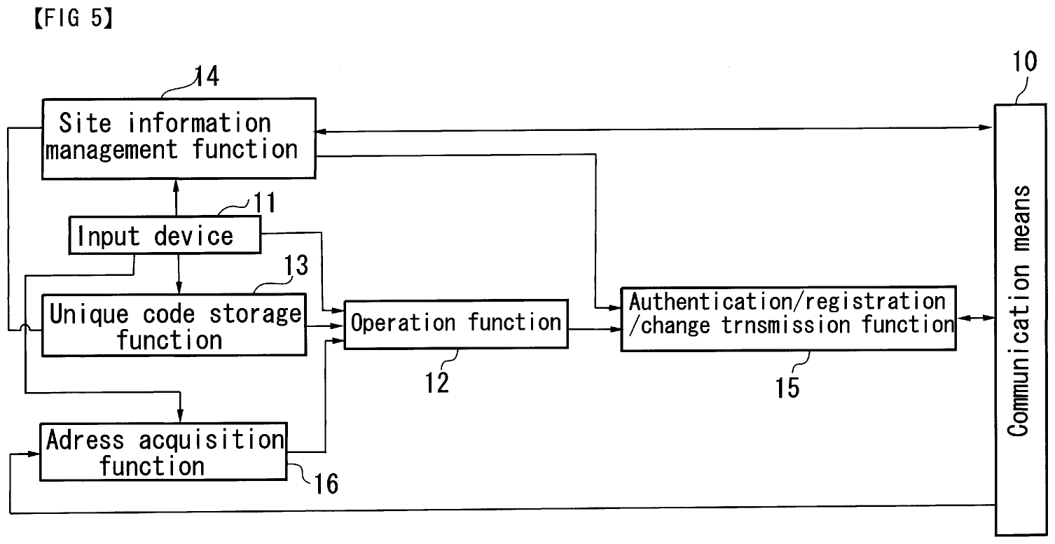

FIG. 5 is a diagram showing a modified example of the terminal module. In this example, the address of the website being accessed is acquired, and the logical operation is performed using the user password, the unique code, and the address of the website being accessed. The same members as those used in FIG. 3 will be described with the same reference numerals. The user accesses the target website. Then, the user inputs the user password into the input device 11. The user password is sent to the operation function 12. In response to the inputting of the user password, the unique code of the designated website is sent to the operation function from the unique code management function 13. In addition, the address acquisition function 16 is activated to acquire the address of the website being accessed. The acquired address is supplied to the operation function 12. The operation function 12 performs the logical operation using the user password, the unique code, and the address of the website, and sends the output as the authentication password to the authentication/registration/change requests transmission function 15. The authentication/registration/change request transmission function generates the password authentication request and so on including the inputted authentication password and the user identification information and sends it to the authentication server.

The present invention is not limited to the above-described embodiments, and various modifications and changes can be made. For example, when changing the authentication password, the user password is changed, a logical operation is performed using the changed user password and the unique code, and the operation result is transmitted to the authentication server together with the user identification information. Then, the registration password specified by the user identification information is rewritten with a new authentication password. Thereby, the setting up work is completed. Thereafter, the authentication process is carried out using the new user password.

### INDUSTRIAL APPLICATION

The present invention can be used in the password authentication system in which the personal authentication is performed using the user password.

1. A password authentication system comprising an authentication server for performing personal authentication using an authentication password, and terminal devices through which users operate, wherein
said terminal device comprises an input means for inputting a user password, a unique code storage means for storing a unique code set for each user, an operation means for logically operating by use of the unique code stored in the unique code storage means and the user password inputted by the user and for outputting an operation result as the authentication password, and a means for transmitting the generated authentication password together with user identification information to the authentication server, and wherein
said authentication server comprises a password storage means for storing the authentication password included in a password registration request sent from the terminal device together with the user identification information as a registration password which functions as a reference for authentication, and a verification means for verifying the matching between the authentication password included in a password authentication request sent from the terminal device and the registration password which is stored in the password storage means and is specified by the user identification information included in the password authentication request, and wherein
when setting up, the terminal device logically operates using the user password inputted by the user and the unique code stored in the unique code storage means to generate the authentication password and transmits the password registration request which includes the generated authentication password to the authentication server, and the authentication server stores the authentication password included in the password registration request together with the user identification information in the password storage means as the registration password, and wherein
when performing the personal authentication, the terminal device logically operates using the user password inputted by the user and the unique code stored in the unique code storage means to generate the authentication password and transmits the password authentication request including the generated authentication password to the authentication server, and the authentication server verifies the matching between the authentication password included in the received password authentication request and the registration password which is stored in the password storage means and is specified by the user identification information included in the received password authentication request.

2. The password authentication system of claim 1, wherein said unique code storage means stores a different unique code for each website on which the authentication server is installed, and wherein
when performing the personal authentication, the user specifies the target website, and the terminal device logically operates using the user password and the unique code of the designated website to output a different authentication password for each website using one and the same user password.

3. The password authentication system of claim 1, wherein a hash operation or an encryption operation is performed as the logical operation, and an outputted hash value or encryption data is used as the authentication password.

4. The password authentication system of claim 1, wherein said unique code includes the address information or domain information of the website.

5. The password authentication system of claim 1, wherein said unique code includes code information given to the user by the authentication server, the unique code set by the user himself or the combination of these code information.

6. The password authentication system of claim 1, wherein said authentication server comprises a unique code generation means for generating the unique code in response to the unique code generation request sent from the terminal device, and transmits the generated unique code to the corresponding terminal deice, and wherein
the terminal device stores the received unique code in the unique code storage means.

7. The password authentication system of claim 6, wherein said authentication server comprises a random number generator as the unique code generation means, generates the random number with a given number of digits in response to a reception of the unique code generation request from the terminal devise, and transmits the generated random number to the terminal device, and wherein
said terminal device stores the received random number in the unique code storage means.

8. The password authentication system of claim 1, wherein said authentication server comprises a password changing means for replacing the registration password stored in the registration password storage means with a new authentication password, and wherein
when changing the password, the user inputs the changed user password into the terminal device, the terminal device logically operates using the changed user password inputted by the user and the unique code stored in the storage means to generate a new authentication password and transmits a password change request including the generated authentication password to the authentication server, and the password changing means of the authentication server replaces the registration password stored in the registration password storage means with the authentication password included in the received password change request.

9. A password authentication system comprising an authentication server for performing personal authentication using an authentication password, and terminal devices through which users operate, wherein
said terminal device comprises an input means for inputting a user password, an address acquisition means for acquiring address information of a website being accessed, an operation means for logically operating by use of the address information acquired by the address acquisition means and the user password inputted by the user to output an operation result as the authentication password, and a means for transmitting the generated authentication password together with user identification information to the authentication server, and wherein
said authentication server comprises a password storage means for storing the authentication password included in a password registration request sent from the terminal device together with the user identification information as a registration password which functions as a reference for authentication, and a verification means for verifying the matching between the authentication password included in a password authentication request sent from the terminal device and the registration password which is stored in the password storage means and is specified by the user identification information included in the password authentication request, and wherein
when setting up, the user accesses the target website, the terminal device acquires the address information of the website being accessed, logically operates using the acquired address information and the user password inputted by the user to generate the authentication password, and transmits the password registration request which includes the generated authentication password to the authentication server, and the authentication server stores the authentication password included in the password registration request together with the user identification information in the password storage means as the registration password, and wherein
when performing the personal authentication, the user accesses the target website, the terminal device acquires the address information of the website being accessed, logically operates using the acquired address and the user password to generate the authentication password, and transmits the password authentication request including the generated authentication password and user identification information to the authentication server, and wherein
the authentication server verifies the matching between the authentication password included in the received password authentication request and the registration password which is stored in the password storage means and is specified by the user identification information included in the received password authentication request.

10. The password authentication system of claim 9, wherein when performing the personal authentication, said terminal device transmits a wrong authentication password which is composed of the code strings different from the registration password to a phishing website.

11. The password authentication system of claim 9, wherein said terminal device comprises a unique code storage means for storing a unique code set for each user, and said operation means logically operates using the user password inputted by the user, the unique code stored in the unique code storage means and the address information of the website being accessed to output the authentication password.

12. The password authentication system of claim 9, wherein said terminal device generates a different authentication password for each website using one user password.

13. The password authentication system of claim 9, wherein as the address information of the website, a URL or a part of the URL of the website, or a domain of the website is used.

14. The password authentication system claim 9, wherein said authentication server installed on the website comprises a password change means for replacing the registration password stored in the password storage means with a new authentication password, and wherein
when changing the password, the user accesses the website subject to the password change and inputs a changed user password, said terminal device acquires the address of the website being accessed, logically operates using the acquired address information of the web site and the inputted user password to generate a new authentication password and transmits a password change request including the generated authentication password to the authentication server on the website, and the password change means of the authentication server replaces the registration password specified by the user identification information included in the password change request with the new authentication password included in the received password change request.

15. A terminal device used in a password authentication system comprising an authentication server for performing personal authentication using an authentication password, and terminal devices through which users operate, wherein
said terminal device comprises an input means for inputting a user password, a unique code storage means for storing a unique code set for each user, an operation means for logically operating by use of the unique code stored in the unique code storage means and the user password inputted by the user to output an operation result as the authentication password, and a means for transmitting the generated authentication password together with user identification information to the authentication server, and wherein
when performing the personal authentication, the terminal device logically operates using the user password inputted by the user and the unique code stored in the unique code storage means to generate the authentication password, and transmits a password authentication request including the generated authentication password to the authentication server.

16. A terminal device used in a password authentication system in which personal authentication is performed using an authentication password, wherein
said terminal device comprises an input means for inputting a user password, an address acquisition means for acquiring an address of a website being accessed, an operation means for logically operating by use of the address acquired by the address acquisition means and the user password inputted by the user to output an operation result as the authentication password, and a means for transmitting the generated authentication password together with user identification information to the authentication server, and wherein
when performing the password authentication, said terminal device acquires the address information of the website being accessed, logically operates using the acquired address information and the inputted user password to generate the authentication password and transmits the generated authentication password to the authentication server on the website, and wherein
said terminal device transmits a wrong authentication password which is composed of a code string different from the registration password which is the reference of authentication to a phishing web site.

17. The terminal device of claim 16, wherein said terminal device comprises a unique code storage means for storing a unique code acting as an operation code used in the logically operation, and said operation means logically operates using the user password inputted by the user, the address information of the website being accessed and the unique code stored in the unique code storage means.
